(19) United States
(12) Patent Application Publication
(10) Pub. No.: US 2005/0012294 A1
(43) Pub. Date: Jan. 20, 2005

(54) Vehicle running board

(75) Inventor: Yin-Shu Yang, Tainan Hsien (TW)

Correspondence Address: BACON & THOMAS, PLLC, 625 SLATERS LANE, FOURTH FLOOR, ALEXANDRIA, VA, 22314, US

(73) Assignee: Her Jiunn Industry Co., Ltd., Tainan Hsien (TW)

(21) Appl. No.: 10/617,677

(22) Filed: Jul. 14, 2003

(51) Int. Cl. B60R 3/00

(52) U.S. Cl. 280/163

(57) ABSTRACT

The vehicle running board of this invention comprises a first side pipe, being hollow inside and having a straight pipe section and a curved pipe section and a fixed base disposed at the curved pipe section; a second side pipe, being hollow inside and having as a straight pipe section and a curved pipe section, and a fixed base disposed at the curved pipe section; a middle pipe, being a hollow straight pipe and having an embedding section on both ends; by means of the foregoing structure, the middle pipe can use the embedding sections to embed between the straight pipe sections of the first and second side pipes respectively.

### BACKGROUND OF THE INVENTION

1. Field of the Invention

This invention relates to a vehicle running board installed under a side of a motor vehicle and having a multi-stage assembly for stepping on.

2. Description of the Related Art

In general, a motor vehicle other than a sedan such as a jeep, a van, or a commercial truck usually has a running board installed under a side of the vehicle. The structure of such running board as the one disclosed in the U.S. Pat. No. 6,050,579 generally has a plurality of fixed bases mounted onto a structure under the side of a vehicle, and a rod with a length approximately equal to the distance between two tires fixed onto each fixed base. Since the vehicle other than the sedan has to provide the function for the passenger at the back seat to step down from the vehicle, the rod generally has dents or wrinkles to give an anti-slippery effect while a passenger steps down from the vehicle.

Since the running board of this kind has a length approximately equal to the distance between two tires, therefore it is not easy to transport and store such a long rod object. More particularly, the speed of developing vans by car manufacturers becomes faster and faster according to the change of purchasing behavior, and the types of vans become more and more in number. The running board manufacturer must prepare a large warehouse and many production lines to deal with such a large inventory with so many complicated specifications. However, no shopping center would like to provide large spaces for displaying and selling the large running boards with so many specifications. Even for mail order, such a long structure will cost a high postage.

### SUMMARY OF THE INVENTION

The objective of this invention is to provide an improved vehicle running board which includes a first side pipe, being hollow inside and having a straight pipe section and a curved pipe section and a fixed base disposed at the curved pipe section; a second side pipe, being hollow inside and having as a straight pipe section and a curved pipe section, and a fixed base disposed at the curved pipe section; a middle pipe, being a hollow straight pipe and having an embedding section on both ends; by means of the foregoing structure, the middle pipe can use the embedding sections to embed between the straight pipe sections of the first and second side pipes respectively.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is an illustrative diagram of the structure of the first preferred embodiment of the present invention.

FIG. 2 is a bottom view of FIG. 1.

FIG. 3 is a cross-sectional diagram of a part of the vehicle running board according to the second preferred embodiment of the present invention.

### DETAILED DESCRIPTION OF THE PREFERRED EMBODIMENTS

In the detailed description of the preferred embodiments, it should be noted that like elements are indicated by the same reference numerals throughout the disclosure.

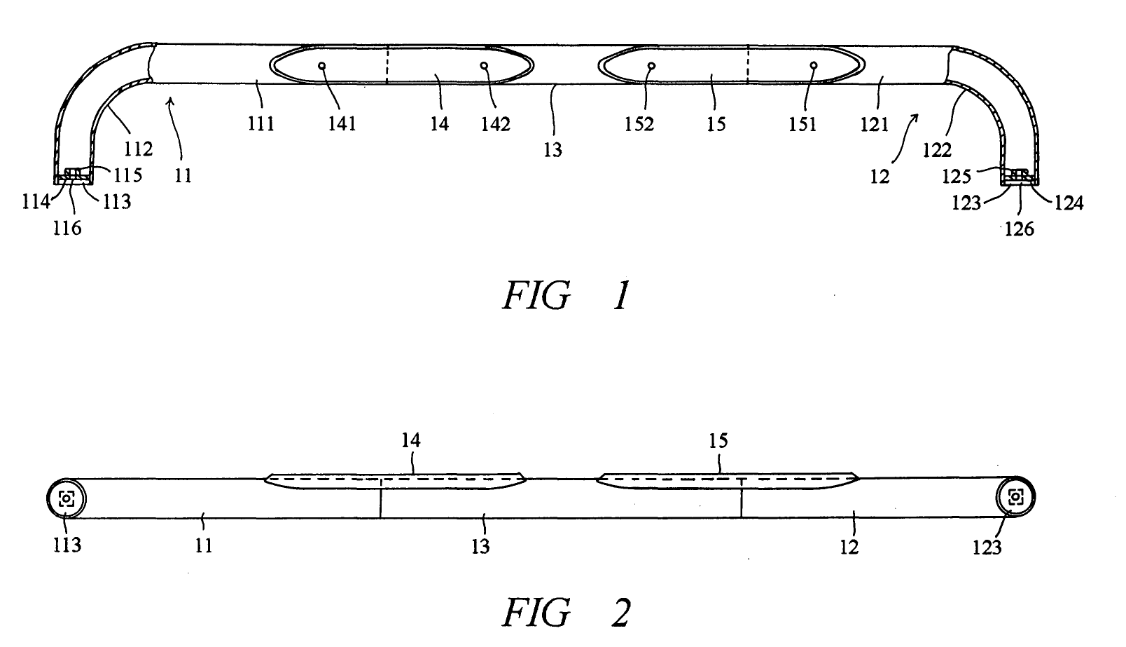

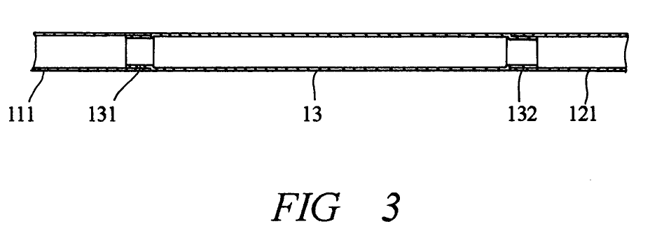

Referring to FIGS. 1 and 2 for a preferred embodiment of the vehicle running board 1, comprising:
a first side pipe 11, being hollow inside and comprising a straight pipe section 111 and a curved pipe section 112, a fixed base 114 soldered at an end opening 113 of the curved pipe 112, a screw nut 115 disposed on the fixed base 114, and a screw hole 116 disposed on the screw nut 115;
a second side pipe 12, being hollow inside and comprising a straight pipe section 121 and a curved pipe section 122, a fixed base 124 soldered at an end opening 123 of the curved pipe 122, a screw nut 125 disposed on the fixed base 124, and a screw hole 126 disposed on the screw nut 125;
a middle pipe 13, being a hollow straight pipe as shown in FIG. 3, having an embedding section 131 with an appropriate length and reduced diameter on both ends of the middle pipe 13, and the embedding sections 131 respectively embedded between the straight pipe sections 111, 121 of the first side pipe 11 and the second side pipe 12 respectively;
a first step mat 14, made of a flexible material and disposed on a pipe between the first side pipe 11 and the middle pipe 13, and a screw fixing component 141, 142 respectively mounted on the first side pipe 11 and the middle pipe 13;
a second step mat 15, made of a flexible material and disposed on a pipe between the second side pipe 12 and the middle pipe 13, and a screw fixing component 151, 152 respectively mounted on the second side pipe 12 and the middle pipe 13;

Since the first and second side pipes 11, 12 and the middle pipe 13 are in the disassembled state, therefore when the three are assembled side by side, the length of the overall package is substantially the same. When the first and second step mats 14, 15 are packed, the length and space of the overall package are smaller to facilitate the transportation, storage, and display. In the assembling as shown in FIGS. 1 and 2, the middle pipe 13 uses the embedding section 131 to respectively embed between the straight pipe sections 111, 112 of the first side pipe 11 and the second side pipe 12, and mount the first and second step mats 14, 15 onto the first side pipe 11, the second side pipe 12, and the middle pipe 13 by a screw fixing component 141, 142, 151, 152 according t the fixing method as described above to complete the assembling, which is very convenient.

The straight pipe section 111 of the first side pipe 11 is intentionally designed with a longer length to distinguish the overall running board direction in order to facilitate the installation onto the vehicle body. When the whole running board is installed, a bolt passes through the fixture of the car body to be mounted into the screw hole 116, 126 in the end opening 113, 123 of the first and second side pipes 11, 12 of the running board.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

1. A vehicle running board, comprising:
a first side pipe, being hollow inside and having a straight pipe section and a curved pipe section, and said curved pipe section having a fixed base;
a second side pipe, being hollow inside and having a straight pipe section and a curved pipe section, and said curved pipe section having a fixed base;
a middle pipe, being a hollow straight pipe and having an embedded section on both ends; by means of the foregoing structure, the middle pipe being used to embed said embedded section between the straight pipe sections of said firs and second side pipes.

2. A vehicle running board as claimed in claim 1, wherein said fixed base is disposed in the end opening of the curved pipe section of the first and second side pipes, and a screw nut and a screw hole formed by said screw hole are disposed on said fixed base.

3. A vehicle running board as claimed in claim 1, wherein said first side pipe having its straight section longer than that of the second side pipe.

4. A vehicle running board as claimed in claim 1, further comprising a step mat.

5. A vehicle running board as claimed in claim 4, wherein said step mat is disposed on a pipe body between said first side pipe and said middle pipe.

6. A vehicle running board as claimed in claim 4, wherein said step mat is disposed on a pipe body between said first side pipe and said middle pipe.
